(19) United States
(12) Patent Application Publication
(10) Pub. No.: US 2010/0103856 A1
(43) Pub. Date: Apr. 29, 2010

(54) METHOD OF TRANSMITTING MULTICAST DATA BASED ON PROXY MOBILE IPv6 DURING HANDOFF

(76) Inventors: Younghan Kim, Seocho-gu (KR); Seil Jeon, Seocho-gu (KR)

Correspondence Address: SHERR & VAUGHN, PLLC, 620 HERNDON PARKWAY, SUITE 320, HERNDON, VA, 20170, US

(21) Appl. No.: 12/606,138

(22) Filed: Oct. 26, 2009

(30) Foreign Application Priority Data
Oct. 29, 2008 (KR) 10-2008-0106324

(51) Int. Cl. H04H 20/71; H04W 36/00

(52) U.S. Cl. 370/312; 370/331

(57) ABSTRACT

Provided is a method of transmitting multicast data based on proxy mobile Internet protocol version 6 (PMIPv6) during handoff. The method includes, when a first access router detects that a mobile node in the region of the first access router moves out of the region, transmitting, at the first access router, a context message informing a second access router adjacent to the first access router of handoff, when the second access router receives the context message, transmitting, at the second access router, a multicast membership report message about the mobile node to a multicast router, and receiving, at the second access router, multicast data from the multicast router and holding the received multicast data.

### TECHNICAL FIELD

The described technology relates generally to a multicast data transmission method and, more particularly, to a method of transmitting multicast data based on proxy mobile Internet protocol version 6 (PMIPv6) during handoff.

### BACKGROUND

IP mobility for IPv6 hosts is specified in Mobile IPv6(MIPv6). MIPv6 requires client functionality in the IPv6 stack of a mobile node. Exchange of signaling messages between the mobile node and home agent enables the creation and maintenance of a binding between the mobile node's home address and its care-of address. Mobility as specified in MIPv6 requires the IP host to send IP mobility management signaling messages to the home agent, which is located in the network. Network-based mobility is another approach to solve the IP mobility challenge. Proxy mobile IPv6(PMIPv6) is intended for providing network-based IP mobility management support to a mobile node, without requiring the participation of the mobile node in any IP mobility related signal. The mobility entities in the network will track the mobile node's movements and will initiate the mobility signaling and set up the required routing state. Thus, PMIPv6 does not require a new IP address for the mobile node when the mobile node moves to another subnet router in the same PMIPv6 domain. In addition, the network detects the mobile node's movements and updates the location information for the mobile node. However, in PMIPv6, when a mobile node moves while a multicast service is being received, a series of processes, such as exchanging of a MLD query message and a MLD report message, for receiving multicast data must be performed after the movement. Thus, a significant delay occurs in receiving multicast data after the movement.

### SUMMARY

Embodiments provide a method of transmitting multicast data based on proxy mobile Internet protocol version 6 (PMIPv6) during handoff in which an existing access router detects movement of a mobile node and transmits a context message informing a new access router of the movement of the mobile node, the new access router receives the context message and performs a membership process in advance, and thus delay of multicast data transmission caused by handoff of the mobile node is reduced.

In one embodiment, a method of transmitting multicast data based on PMIPv6 during handoff is provided. The method includes: when a first access router detects that a mobile node in a region of the first access router moves out of the region, transmitting, at the first access router, a context message informing a second access router of handoff; when the second access router receives the context message, transmitting, at the second access router, a multicast membership report message about the mobile node to a multicast router; and receiving, at the second access router, multicast data from the multicast router.

The Summary is provided to introduce a selection of concepts in a simplified form that are further described below in the Detailed Description. The Summary is not intended to identify key features or essential features of the claimed subject matter, nor is it intended to be used as an aid in determining the scope of the claimed subject matter.

### BRIEF DESCRIPTION OF THE DRAWINGS

The above and other features and advantages of the present disclosure will become more apparent to those of ordinary skill in the art by describing in detail example embodiments thereof with reference to the attached drawings in which:

FIG. 1 illustrates the structure of a multicast data transmission system based on proxy mobile Internet protocol version 6 (PMIPv6) according to an embodiment;

FIG. 2 is a flowchart illustrating a method of transmitting multicast data based on PMIPv6 according to an embodiment; and

FIG. 3 illustrates an example of a context message that an existing access router detecting movement of a mobile node transmits to a new access router to inform of the movement.

### DETAILED DESCRIPTION

It will be readily understood that the components of the present disclosure, as generally described and illustrated in the Figures herein, could be arranged and designed in a wide variety of different configurations. Thus, the following more detailed description of the embodiments of apparatus and methods in accordance with the present disclosure, as represented in the Figures, is not intended to limit the scope of the disclosure, as claimed, but is merely representative of certain examples of embodiments in accordance with the disclosure. The presently described embodiments will be best understood by reference to the drawings, wherein like parts are designated by like numerals throughout. Moreover, the drawings are not necessarily to scale, and the size and relative sizes of layers and regions may have been exaggerated for clarity.

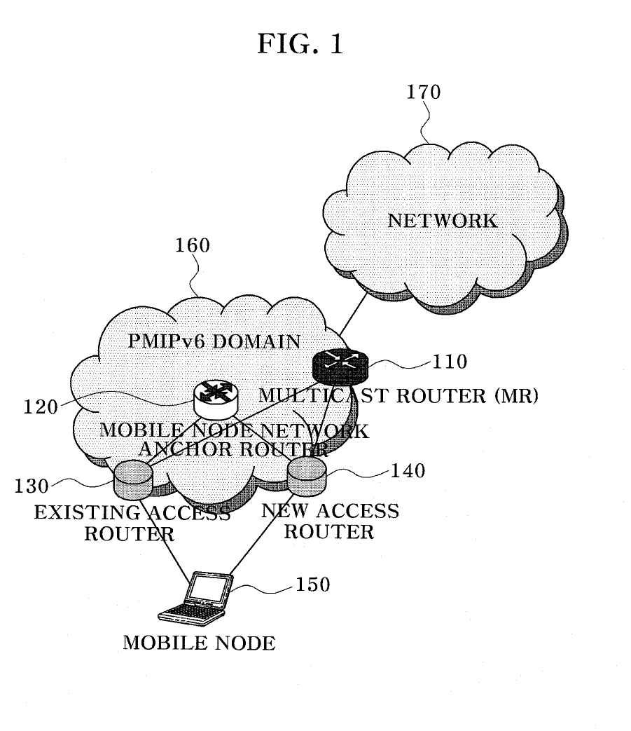

FIG. 1 illustrates the structure of a system for transmitting multicast data based on proxy mobile Internet protocol version 6 (PMIPv6) during handoff according to an embodiment. Referring to FIG. 1, the PMIPv6-based multicast data transmission system includes a multicast router (MR) 110, a mobile node (MN) network anchor router 120, an existing access router 130, a new access router 140, and a MN 150. The MR 110, the MN network anchor router 120, the existing access router 130, and the new access router 140 constitute a PMIPv6 domain 160, and the PMIPv6 domain 160 is connected with a network 170.

The MR 110 connects the access routers 130 and 140 to the network 170 such as an IP network. The MR 110 exchanges a multicast membership message with the access routers 130 and 140 and transmits multicast data to the access routers 130 and 140. For example, the multicast membership message may be a multicast listener discovery (MLD) message used to exchange membership eligibility status information between an IPv6 router supporting multicasting and a multicast group member of a network segment. The MLD message is defined in request for comments (RFC) 2710, “Multicast Listener Discovery (MLD) for IPv6.” More specifically, to determine whether any MN belongs to a multicast group, the MR 110 periodically transmits a multicast membership query message to the access routers 130 and 140 and receives a multicast membership report message, which is a response message to the multicast membership query message, from the access routers 130 and 140. After the multicast membership report message is received, the multicast router 110 transmits multicast data to the access routers 130 and 140.

The MN network anchor router (referred to as “anchor router” below) 120 constitutes the PMIPv6 domain 160 together with the access routers 130 and 140. The anchor router 120 exchanges a proxy binding update (PBU) message, a proxy binding acknowledgement (PBA) message, etc., with the access routers 130 and 140 to generate a bidirectional IP tunnel, and exchanges data packets with the access routers 130 and 140 through the bidirectional IP tunnel. More specifically, when a PBU message is received from the existing access router 130, the anchor router 120 registers the address of the existing access router 130 for the MN 150 and transmits a PBA message including a home network prefix to be assigned to the MN 150 to the existing access router 130. At this time, the anchor router 120 generates a bidirectional IP tunnel connected with the existing access router 130 to exchange data packets with the existing access router 130. Also, when handoff occurs due to movement of the MN 150 and a PBU message is received from the new access router 140, the anchor router 120 changes an access router address for the MN 150 from the address of the existing access router 130 to the address of the new access router 140 and transmits a PBA message including a home network prefix to be assigned to the MN 150 to the new access router 140. This home network prefix is the same as the home network prefix transmitted to the existing access router 130. The anchor router 120 establishes a bidirectional IP tunnel connected with the new access router 140 to exchange data packets with the new access router 140.

The existing access router 130 connects the MN 150 to the MR 110 and the anchor router 120. The existing access router 130 receives multicast data that is data transmitted according to a multicast transmission method from the MR 110 and transmits the multicast data to the MN 150. The existing access router 130 receives data transmitted according to a unicast transmission method from the anchor router 120 and transmits the data to the MN 150. More specifically, the existing access router 130 periodically receives a multicast membership query message from the MR 110, transmits the multicast membership query message to the MN 150, receives a multicast membership report message from the MN 150, and transmits the multicast membership report message to the MR 110. Thus, the MN 150 can receive multicast data through the existing access router 130. The existing access router 130 receives multicast data from the MR 110 and transmits the multicast data to the MN 150. Also, the existing access router 130 establishes a bidirectional IP tunnel to the anchor router 120 through a proxy binding update process and exchanges unicast data with the anchor router 120 through the bidirectional IP tunnel. The existing access router 130 detects that the MN 150 moves out of the region of the existing access router 130 based on attenuation of a downlink signal and transmits a context message informing the new access router 140 of handoff. The context message includes the home network prefix and media access control (MAC) address of the MN 150.

When the context message is received from the existing access router 130, the new access router 140 registers the MAC address of the MN 150 included in the context message and immediately transmits a multicast membership report message to the MR 110. Thus, the new access router 140 may receive multicast data from the MR 110 and transmit the multicast data to the MN 150. The new access router 140 establishes a bidirectional IP tunnel to the anchor router 120 through a proxy binding update process and exchanges unicast packets with the anchor router 120 through the bidirectional IP tunnel.

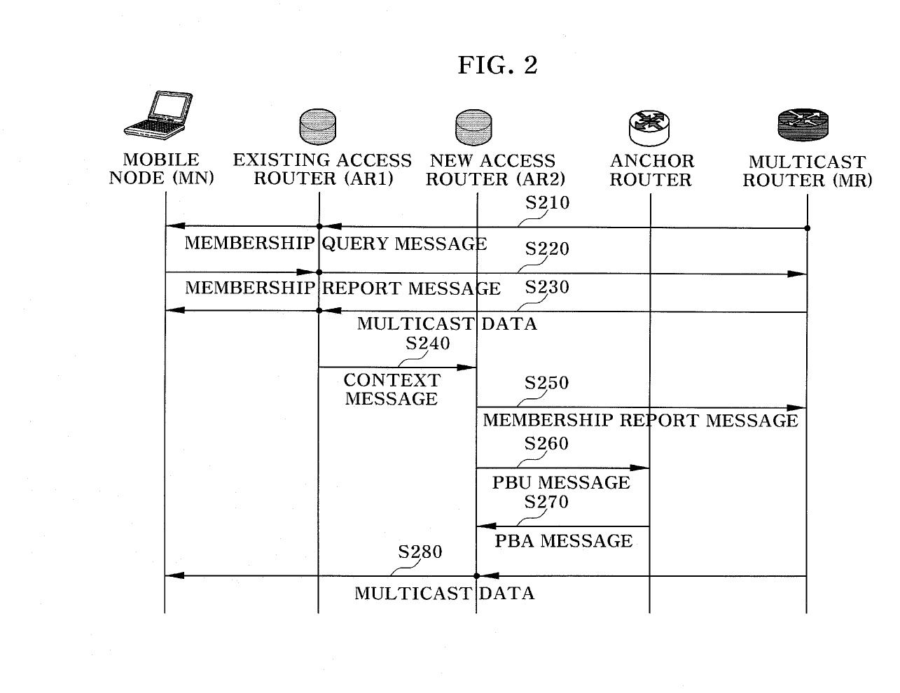

FIG. 2 is a flowchart illustrating a method of transmitting multicast data based on PMIPv6 during handoff according to an embodiment.

Referring to FIG. 2, in operation 210, a MR transmits a multicast membership query message to a MN via an existing access router AR1. This is because the MR needs to know whether any MN belongs to a multicast group. For example, the multicast membership query message is a MLD query message.

In operation 220, the MN transmits a multicast membership report message corresponding to the multicast membership query message to the MR via the existing access router AR1. For example, the multicast membership report message is a MLD report message. Thus, the MN may receive multicast data via the MR and the existing access router AR1.

In operation 230, the MR transmits multicast data to the MN via the existing access router AR1.

In operation 240, when the MN moves out of the region of the existing access router AR1, the existing access router AR1 detects the movement based on attenuation of a downlink signal and transmits a context message informing an adjacent new access router AR2 of handoff. The context message includes the home network prefix and MAC address of the MN.

In operation 250, the new access router AR2 registers the MAC address of the MN included in the context message and immediately transmits a multicast membership report message to the MR. Thus, when the MN enters the region of the new access router AR2, the MN may immediately receive multicast data through the new access router AR2.

In operation 260, the new access router AR2 transmits a PBU message to a MN network anchor router (referred to as “anchor router” below).

In operation 270, the anchor router changes the address of the access router AR1 corresponding to the MN to the address of the new access router AR2, transmits a PBA message including the home network prefix information of the MN to the new access router AR2, and establishes a bidirectional IP tunnel to the new access router AR2. Through the bidirectional IP tunnel, unicast data may be exchanged between the anchor router and the new access router AR2.

In operation 280, the MR transmits multicast data to the new access router AR2.

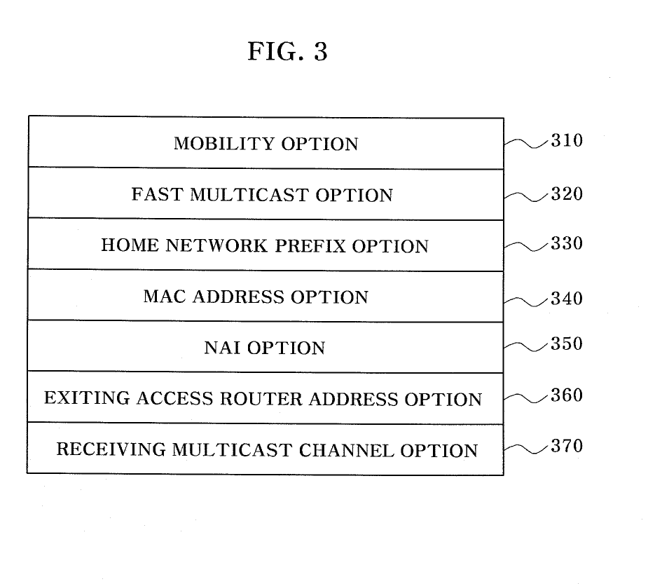

FIG. 3 illustrates an example of a context message that the existing access router AR1 detecting movement of the MN transmits to the new access router AR2 to inform of the movement. Referring to FIG. 3, the context message includes a mobility option 310, a fast multicast option 320, a home network prefix option 330 of the MN, a MAC address option 340 of the MN, a network access identifier (NAI) option 350 of the MN, an existing access router address option 360, and a receiving multicast channel option 370. Here, the mobility option 310 and the fast multicast option 320 are intended to indicate that the context message is for registering a multicast channel in advance. The home network prefix option 330 of the MN is intended to transfer the home network prefix that is assigned to the MN. The MAC address option 340 of the MN is intended to directly transfer multicast data to the MN without searching for the MN, and the NAI option 350 of the MN is intended to transfer the interface identifier of the MN. The existing access router address option 360 is intended to indicate from which access router the context message is received, and the receiving multicast channel option 370 is intended to indicate a multicast channel desired to be received.

An embodiment of the present disclosure can be implemented as machine readable codes in a machine readable recording medium. The computer readable recording medium includes all types of recording media in which machine readable data are stored. Examples of the machine readable recording medium include a ROM, a RAM, a CD-ROM, a magnetic tape, a floppy disk, and an optical data storage. In addition, the machine readable recording medium may be distributed to several machines over a network, in which machine readable codes may be stored and executed in a distributed manner. A functional program, code, and code segments for implementing an embodiment of the present disclosure can be readily deduced by programmers in the technical field of the present disclosure.

As described above, in an embodiment, an access router detects movement of a mobile node and transmits a context message informing a new access router of the movement, and the new access router performs a membership process of transmitting a multicast membership report message to a multicast router in advance. Consequently, it is possible to reduce delay for exchanging a multicast membership query message and a multicast membership report message caused by the handoff.

The foregoing is illustrative of the present disclosure and is not to be construed as limiting thereof. Although numerous embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

1-5. (canceled)

6. A method of transmitting multicast data, based on proxy mobile Internet protocol version 6, during a handoff, comprising:
transmitting, from a first access router, a context message informing a second access router of a handoff, when a first access router detects that a mobile node in a region of the first access router moves out of the region, wherein the second access router is adjacent to the first access router;
transmitting, from the second access router, a multicast membership report message about the mobile node to a multicast router, when the second access router receives the context message; and
receiving and holding, at the second access router, multicast data received from the multicast router.

7. The method according to claim 6, wherein the multicast membership report message is a report message defined in multicast listener discovery protocol.

8. The method according to claim 6, further comprising performing, at the second access router and at a mobile node network anchor router, a proxy binding update process to establish a bidirectional IP tunnel between the second access router and the mobile node network anchor router.

9. The method according to claim 6, wherein the context message includes home network prefix information and a media access control address of the mobile node.

10. The method according to claim 6, wherein transmitting, from the second access router, a multicast membership report message about the mobile node to a multicast router is performed before the mobile node completes the handoff.
